(19) United States
(12) Patent Application Publication
(10) Pub. No.: US 2009/0218809 A1
(43) Pub. Date: Sep. 3, 2009

(54) PRESSURIZED-FLUID PIPE MADE OF THERMOPLASTIC MATERIAL, IN PARTICULAR POLYOLEFIN MATERIAL, WITH A BELL END

(76) Inventor: Giorgio Tabanelli, Cotignola (IT)

Correspondence Address: KLARQUIST SPARKMAN, LLP, 121 SW SALMON STREET, SUITE 1600, PORTLAND, OR, 97204, US

(21) Appl. No.: 12/278,950

(22) PCT Filed: Feb. 8, 2007
(86) PCT No.: PCT/EP2007/051234

§ 371 Date: Nov. 21, 2008

(30) Foreign Application Priority Data
Feb. 13, 2006 (IT) BO2006A 000101

(51) Int. Cl. F16L 47/12

(52) U.S. Cl. 285/104

(57) ABSTRACT

A pressurized-fluid pipe of thermoplastic material has a given longitudinal axis; and a bell end, which is connected to a second pipe in fluidtight manner by an annular lip seal, and in axially fixed manner by an annular retaining member, which lip seal and retaining member are housed inside one seat formed in an inner surface of the bell end.

### TECHNICAL FIELD

The present invention relates to a pipe made of thermoplastic material, with a bell end.

The present invention may be used to particular advantage in relatively thick pipes made of polyolefin material such as polyethylene or polypropylene, and therefore capable of conducting pressurized fluid, to which the following description refers purely by way of example.

### BACKGROUND ART

A pressurized-fluid pipe of polyolefin material is known comprising a given longitudinal axis, and a bell end for connecting the pipe to a second pipe inserted into the bell end.

The bell end is fitted to the second pipe in fluidtight manner with the interposition of an annular lip seal, and in axially fixed manner by means of a toothed annular retaining member.

The annular lip seal and toothed annular retaining member are housed inside respective seats formed in an inner surface of the bell end.

The bell end and relative seats are normally formed using two known methods.

In a first method, the end of the pipe is defined by a tubular fitting, which is first injection-molded into a bell shape, is then machined to form the seats, and is finally butt welded to the normally extruded pipe.

In the second known method, the end of the pipe is first heated, is then engaged by a forming die shaped to form the bell end and the annular lip seal seat simultaneously, and is finally machined to form the toothed annular retaining member seat.

Given the presence of two separate seats for the annular lip seal and the toothed annular retaining member, forming the bell end of known pipes of the type described above therefore involves relatively complex, high-cost, time-consuming production processes.

### DISCLOSURE OF INVENTION

It is an object of the present invention to provide a pipe made of thermoplastic material, with a bell end, designed to eliminate the aforementioned drawbacks.

According to the present invention, there is provided a pipe made of thermoplastic material, with a bell end, as claimed in the accompanying Claims.

### BRIEF DESCRIPTION OF THE DRAWINGS

A non-limiting embodiment of the present invention will be described by way of example with reference to the accompanying drawings, in which:

FIG. 1 shows a schematic longitudinal section of a preferred embodiment of the pipe according to the present invention;

FIG. 2 shows a larger-scale, schematic longitudinal section of a detail of the FIG. 1 pipe.

### BEST MODE FOR CARRYING OUT THE INVENTION

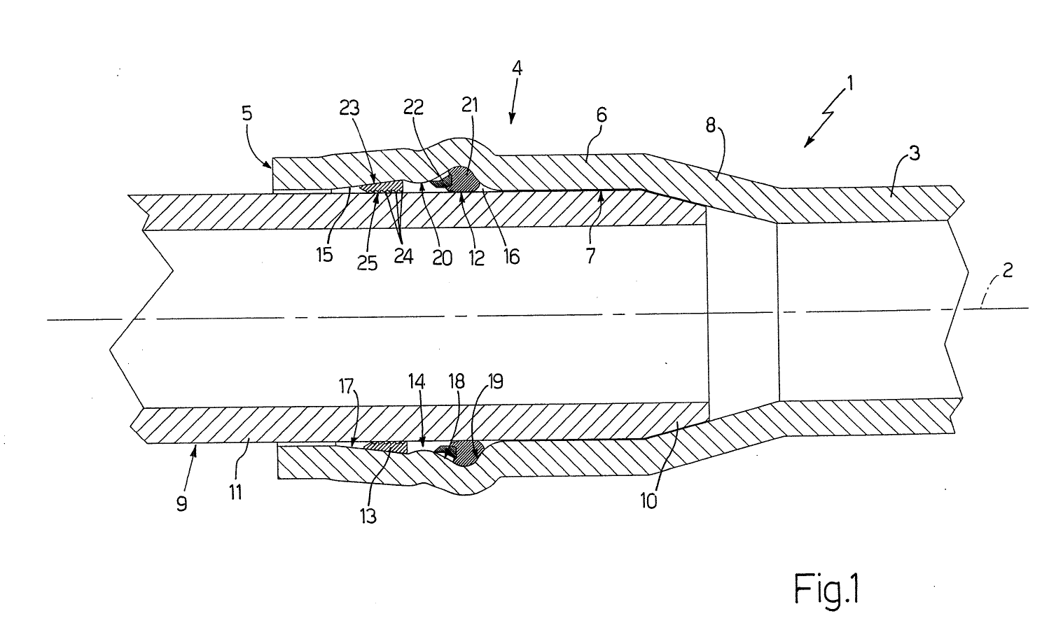

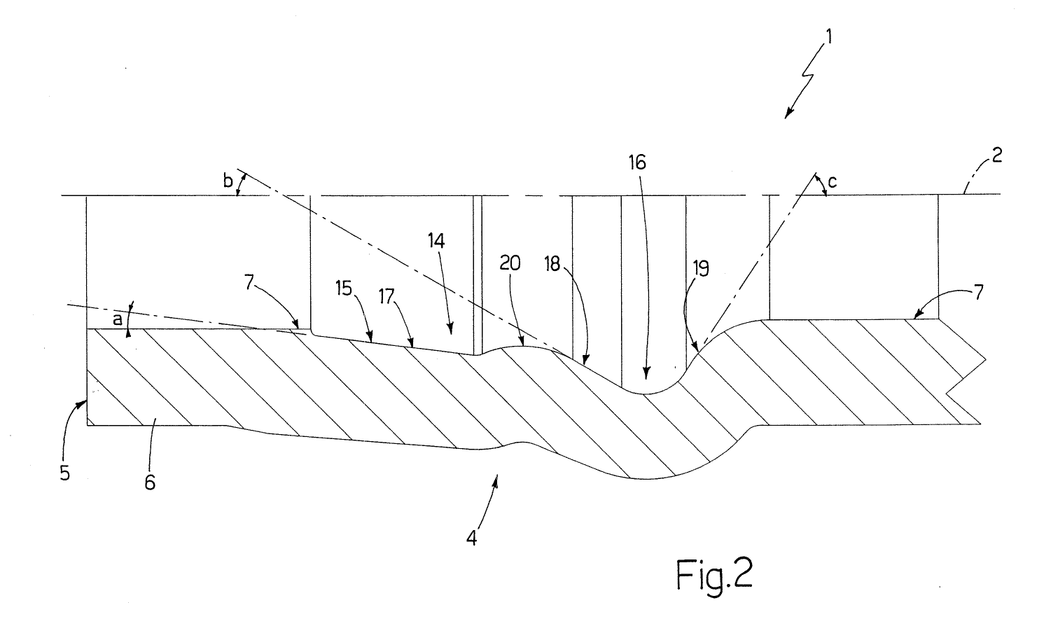

Number 1 in FIGS. 1 and 2 indicates as a whole a pipe made of thermoplastic material, and which comprises a given longitudinal axis 2, is made of polyolefin material such as polyethylene or polypropylene, and is relatively thick for conducting pressurized fluid.

In the example shown, pipe 1 has a substantially circular cross section, and comprises a substantially cylindrical portion 3 coaxial with axis 2; and a bell end 4, which is bounded axially by a substantially flat surface 5 perpendicular to axis 2, has a wall thickness normally greater than that of portion 3, and comprises an end portion 6 bounded internally by a substantially cylindrical surface 7 and coaxial with axis 2, and a substantially truncated-cone-shaped intermediate portion 8 connecting portion 6 and portion 3.

End 4 provides for connecting pipe 1 to a pipe 9, which is fitted inside end 4, coaxially with axis 2, and comprises a substantially truncated-cone-shaped end portion 10 inserted inside portion 8; and a substantially cylindrical portion 11 inserted inside portion 6.

End 4 is fitted in fluidtight manner to pipe 9 with the interposition of an annular lip seal 12—in the example shown, a fluidtight lip seal known by the trade name F-576 Anger-Lock™—and is fitted in axially fixed manner to pipe 9 with the interposition of a toothed annular retaining member 13.

Seal 12 and member 13 are housed inside one seat 14 formed in surface 7, at an intermediate point along portion 6, and comprising, as of surface 5, two portions 15, 16 arranged successively along axis 2 and housing member 13 and seal 12 respectively.

Portion 15 is bounded by a substantially truncated-cone-shaped surface 17, which converges towards surface 5, slopes with respect to axis 2 by an angle a (FIG. 2) of less than 30° and preferably ranging between 6° and 10°, and is connected to surface 7 with a given radius of curvature.

In a variation not shown, surface 17 is connected to surface 7 by a substantially truncated-cone-shaped surface sloping with respect to axis 2 by an angle greater than angle a, or by a flat surface substantially perpendicular to axis 2.

Portion 16 is bounded by two substantially truncated-cone-shaped surfaces 18, 19 with opposite concavities; surface 18 slopes by a substantially 30° angle b (FIG. 2) with respect to axis 2; and surface 19 slopes by a substantially 60° angle c (FIG. 2) with respect to axis 2, and is connected to surface 7 with a given radius of curvature.

Surface 18 and, therefore, portion 16 are connected to surface 17, and therefore to portion 15, by an annular shoulder 20, which projects towards axis 2, coaxially with axis 2, to separate portions 15 and 16 and prevent any interference between seal 12 and member 13, has a minimum diameter larger than the diameter of surface 7, and is connected to surfaces 17 and 18 with respective given radii of curvature.

Seal 12 comprises a sealing portion 21 made of elastomeric material and substantially facing surface 19; and a stiffening portion 22, which is made of plastic material, substantially faces surface 18, and provides for ensuring a high degree of rigidity of seal 12, and for stabilizing seal 12 firmly inside seat 14.

Member 13 is bounded externally by a substantially truncated-cone-shaped surface 23 facing and contacting surface 17, and has a number of gripping teeth 24 formed on its substantially cylindrical inner surface 25 coaxial with axis 2. In a variation not shown, surface 23 also has gripping teeth.

It should be pointed out that, with seat 14 so designed, end 4 can be formed using various production methods, such as the one described in European Patent Application n. 05425862.9, which is included integrally herein by way of reference.

1. A pressurized-fluid pipe made of thermoplastic material, in particular polyolefin material, with a bell end, the pipe having a given longitudinal axis, and comprising a bell end for connection to a second pipe inserted at least partly inside the bell end;
the bell end bounded by an inner surface extending about said axis, and the bell end having an annular lip seal n to connect the pipe in fluidtight manner to the second pipe, and an annular retaining member to connect the pipe in axially fixed manner to the second pipe, and the pipe being characterized in that said bell end comprises one seat formed in said inner surface to house both said annular lip seal and said annular retaining member.

2. A pipe as claimed in claim 1, wherein said seat comprises a first and a second portion arranged successively along said axis to house said annular retaining member and said annular lip seal respectively; and an annular connecting shoulder between said first and said second portion.

3. A pipe as claimed in claim 2, wherein said first portion is bounded by a substantially truncated-cone-shaped first surface sloping by a first angled of less than with respect to said axis.

4. A pipe as claimed in claim 3, wherein said first angle ranges between 6° and 10°.

5. A pipe as claimed in claim 2, wherein said second portion is bounded by a second and a third substantially truncated-cone-shaped surface with opposite concavities.

6. A pipe as claimed in claim 5, wherein said second and said third surface slope by a substantially 30° second angled and a substantially 60° third angle respectively with respect to said axis.

7. A pipe as claimed in claim 3, wherein said first surface is connected to said inner surfaces by a substantially truncated-cone-shaped fourth surface sloping with respect to said axis by a fourth angle greater than said first angles.

8. A pipe as claimed in claim 3, wherein said first surface is connected to said inner surfaces by a substantially flat fourth surface perpendicular to said axis.

9. A pipe as claimed in claim 3, wherein said first surface is connected to said inner surface with a given radius of curvature.

10. A pipe as claimed in anyone of claim 2, wherein said first and said second portion are bounded by a first and a second substantially truncated-cone-shaped surface, which are connected to said shoulder with respective given radii of curvature.

11. A pipe as claimed in claim 1, wherein said annular lip seal comprises a sealing portion of elastomeric material; and
a stiffening portion of plastic material to lock the annular lip seal inside said seat.

12. A pipe as claimed in claim 1, wherein said annular retaining member is externally substantially truncated-cone-shaped, and has a number of inner gripping teeth.
